(19) United States
(12) Patent Application Publication
(10) Pub. No.: US 2010/0134393 A1
(43) Pub. Date: Jun. 3, 2010

(54) ENHANCE DRIVING MODULATION METHOD AND THE DEVICE FOR FIELD SEQUENTIAL COLOR LIQUID CRYSTAL DISPLAY

(76) Inventors: Chia-Hui CHEN, Taichung County (TW); Chiu-Yuan HUANG, Taichung City (TW); Chun-Tsai CHIEN, Taichung City (TW)

Correspondence Address: Muncy, Geissler, Olds & Lowe, PLLC, 4000 Legato Road, Suite 310, FAIRFAX, VA, 22033, US

(21) Appl. No.: 12/327,300

(22) Filed: Dec. 3, 2008

(51) Int. Cl. G09G 3/36

(52) U.S. Cl. 345/88

(57) ABSTRACT

The present invention discloses an FSC LCD enhance driving modulation method, which modulates the timing signal that controls the liquid crystal optical gate to shorten the transit delay caused by optical response delay of liquid crystal and thus increases luminous flux and improves color saturation. The present invention also controls the multi-color backlight source to sequentially emit at least two colored backlights with a dark interval therebetween. The present invention further controls the transit delay to coincide with the dark interval, whereby the latter colored backlight will not mix with the former colored backlight during the transit delay, wherefore the present invention can avoid the color deviation caused by color mixing and can present the designed colors correctly.

### FIELD OF THE INVENTION

The present invention relates to a display method for an FSC LCD, particularly to an FSC LCD enhance driving modulation method, which can increase luminous flux and improve color saturation.

### BACKGROUND OF THE INVENTION

In FSC LCD (Field Sequential Color Liquid Crystal Display), multi-color backlights are sequentially emitted and pass through liquid crystal optical gates. FSC LCD opens and closes the liquid crystal optical gates to sequentially generate pure-color fields, and then the visual persistence of human eyes mixes the pure colors to present various colors. Refer to FIG. 1. The timing signal 1 is used to open and close the liquid crystal optical gates. However, the light transmission curve 2 cannot fully reflect because the delayed response of liquid crystal molecules. Thus, there are open delays 3 and close delays 4 appearing in the light transmission curve 2. There is also a color backlight control signal 5B switching a multi-color backlight source at the time point of ON/OFF. When it is at the time point of ON, the color backlight control signal 5B controls the multi-color backlight source to emit a color backlight 5, and then the color backlight passes through liquid crystal optical gates.

Refer to FIG. 2. The color backlight 5 of the multi-color backlight source includes a red backlight (R) 6, a green backlight (G) 7 and a blue backlight (B) 8, which are sequentially emitted. The liquid crystal optical gate has three light transmission curves 2 (designated by r, g, and b) corresponding to the sequentially-emitted red backlight (R) 6, green backlight (G) 7 and blue backlight (B) 8. The close delays 4 of the light transmission curves 2 extend to the time intervals for the latter-color backlight. In other words, the green backlight 7 appears in a portion of the time interval for the red backlight 6; the blue backlight 8 appears in a portion of the time interval for the green backlight 7; the red backlight 6 appears in a portion of the time interval for the blue backlight 8. Thus, color deviations appear in human eyes. When the liquid crystal optical gate generates other light transmission curves 2 (designated by c, m, and y) to mix two pure color lights, the close delays 4 of the light transmission curves 2 (c, m, and y) also extend to the time intervals for the latter-color backlight. Thus, color deviations also appear in human eyes in the color-mixing case.

Refer to FIG. 3. To solve the abovementioned problem, there has been a conventional technology generating a modulated timing signal 1A to change the manner of a light transmission curve 2A, whereby the open delays 3A and close delays 4A completely fall inside the time intervals for the same color backlight 5A. Thus is overcome color deviation in FCS LCD. However, such an approach decreases the luminous fluxes of red backlight 6A, green backlight 7A and blue backlight 8A, and degrades brightness and color saturation. Therefore, the prior arts cannot meet the requirements of a display.

### SUMMARY OF THE INVENTION

The primary objective of the present invention is to provide an offset modulation method to increase luminous flux and improve color saturation.

Another objective of the present invention is to increase luminous flux but retain the purity of colors, whereby color saturation is improved without the problem of color deviation.

To achieve the abovementioned objectives, the present invention comprises steps:

providing a multi-color backlight source sequentially emitting at least two colored backlights;

providing a liquid crystal optical gate illuminated by the colored backlights and having a light blocking state and a light permeable state; and

providing a timing signal generated by a controller and having a normal state, a metastable state, and an enable state, wherein the timing signal is normally at the metastable state and switched to the normal state and the enable state to drive the liquid crystal optical gate to the light blocking state or the light permeable state, whereby the liquid crystal optical gate creates a light transmission curve having a transit delay in the transition between each two of the normal state, the metastable state and the enable state.

In the present invention, the timing signal has a short over-level signal and a metastable signal in the transition between each two of the normal state, the metastable state and the enable state to accelerate switching the liquid crystal optical gate and shorten the transit delay.

The present invention arranges a dark interval in the transition of the colored backlights and controls the transit delay to coincide with the dark interval, whereby the latter colored backlight will not mix with the former colored backlight during the transit delay.

Therefore, the present invention can shorten the transit delay and thus increases luminous flux and improves color saturation. Further, when generating pure-color lights, the present invention can prevent the active colored backlight from mixing with another colored backlight during the transit delay and thus can avoid color deviation; when generating mixed-color lights, the present invention can present the designed colors correctly.

### BRIEF DESCRIPTION OF THE DRAWINGS

FIG. 1 is a diagram showing the optical response of liquid crystal of a conventional technology;

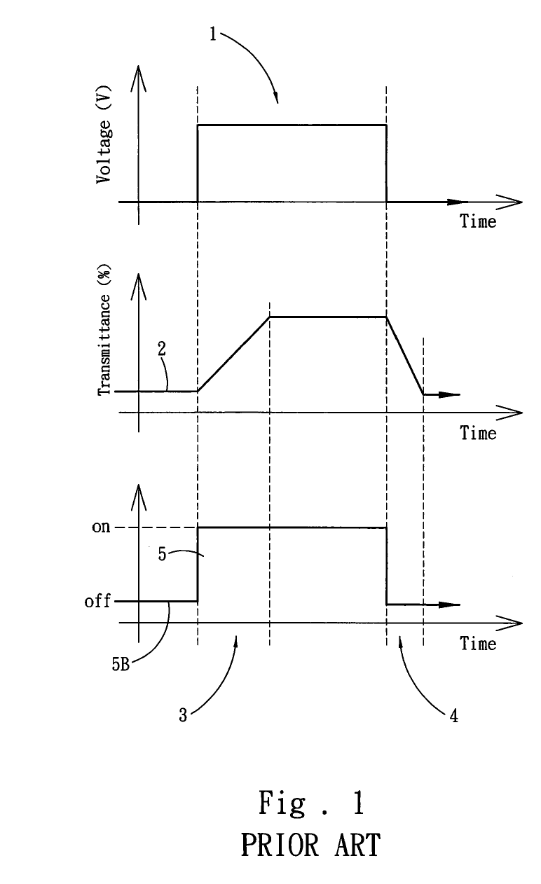

FIG. 2 is a diagram showing the timing charts of a conventional FSC LCD;

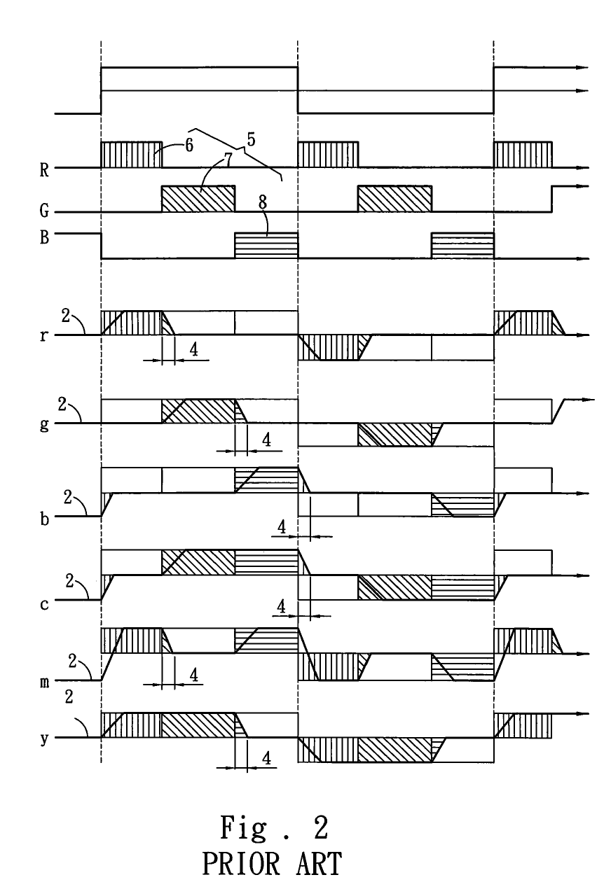

FIG. 3 is a diagram showing the timing charts of another conventional FSC LCD;

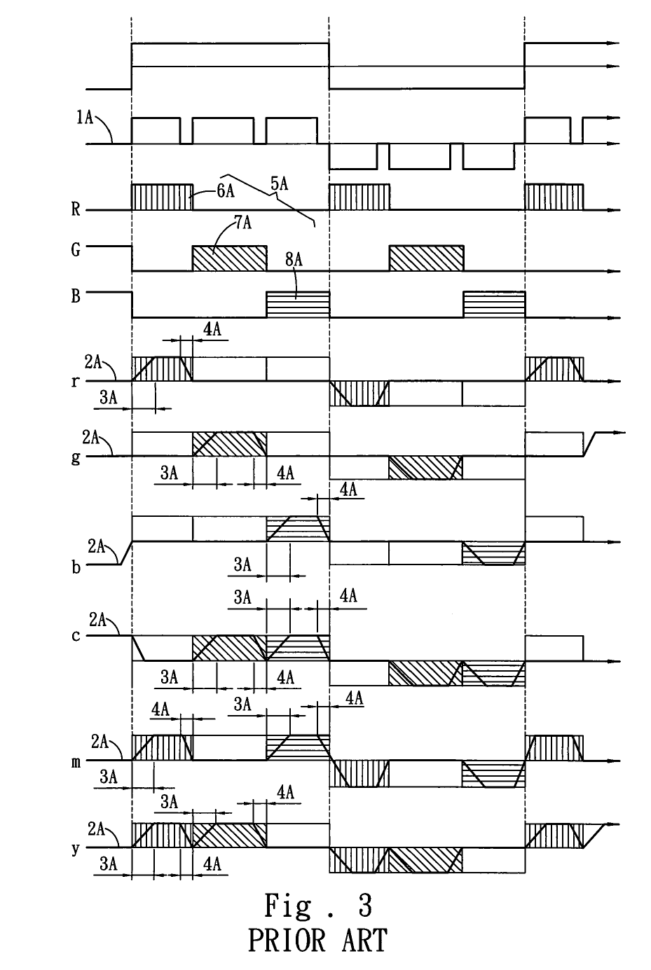

FIG. 4 is a diagram schematically showing an FSC offset modulation device using the method of the present invention;

FIG. 5 is a diagram showing the timing charts of an FSC LCD using the method of the present invention; and

FIG. 6 is a diagram showing the timing charts of the control signal according to the present invention.

### DETAILED DESCRIPTION OF THE PREFERRED EMBODIMENTS

Below, the technical contents of the present invention will be described in detail in cooperation with the drawings.

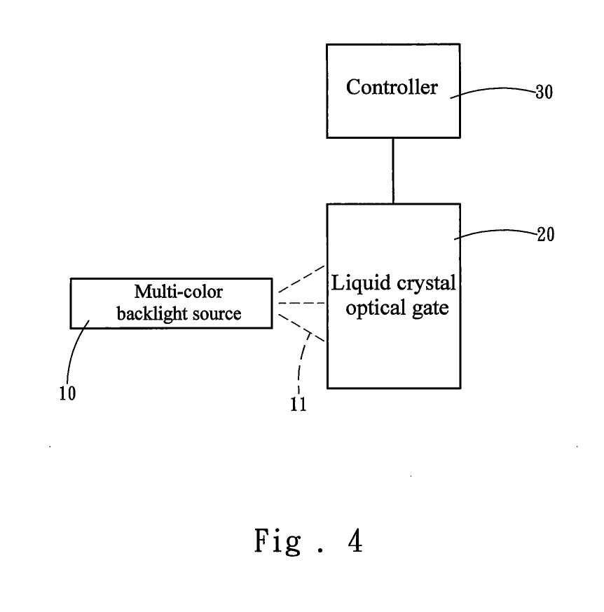

Refer to FIG. 4 a diagram schematically showing a device using the method of the present invention. The device comprises a multi-color backlight source 10, a liquid crystal optical gate 20, and a controller 30. The multi-color backlight source 10 is arranged near the liquid crystal optical gate 20, and the controller 30 is electrically coupled to the multi-color backlight source 10 and the liquid crystal optical gate 20.

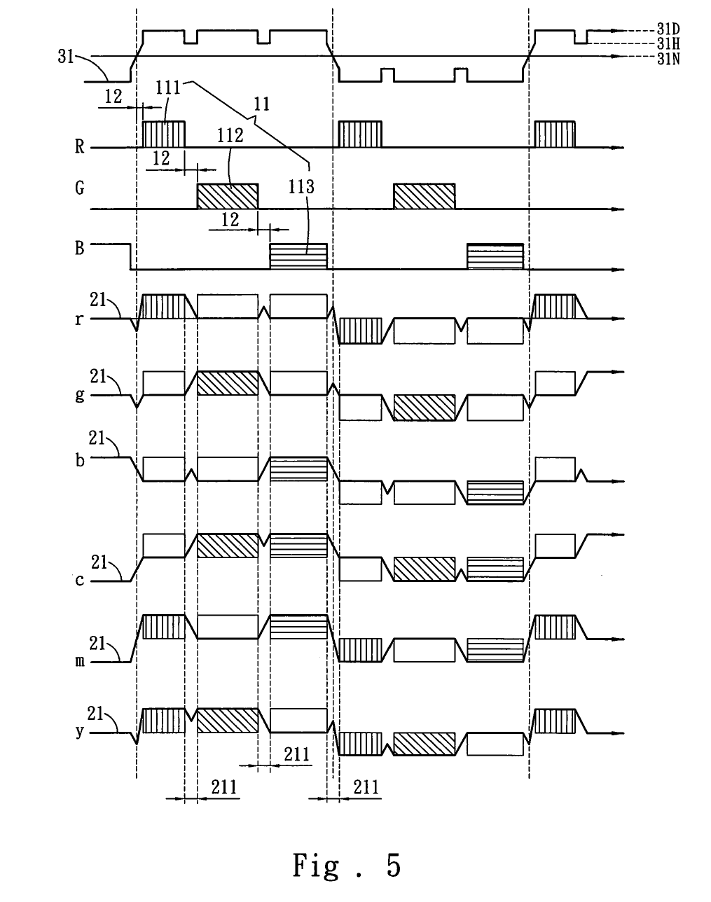

Refer to FIG. 5. The multi-color backlight source 10 sequentially emits at least two colored backlights 11 with a dark interval 12 therebetween. The colored backlights 11 include a red backlight 111, a green backlight 112 and a blue backlight 113. The colored backlight 11 may have the dark interval 12 at the instant that the multi-color backlight source 10 begins to emit the colored backlight 11.

The colored backlights 11 are projected onto the liquid crystal optical gate 20. The liquid crystal optical gate 20 has a light blocking state and a light permeable state. The controller 30 generates a timing signal 31. The timing signal 31 may be an alternating signal. The time interval of two opposite phases of the timing signal 31 is equal to the time interval to sequentially emit the red backlight 111, green backlight 112 and blue backlight 113 once. The timing signal 31 has a normal state 31N, a metastable state 31H, and an enable state 31D. The timing signal 31 is normally at the metastable state 31H and switched to the normal state 31N and the enable state 31D to drive the liquid crystal optical gate 20 to the light blocking state or the light permeable state. Thereby, the liquid crystal optical gate 20 creates light transmission curves 21 having a transit delay 211 in the transition between each two of the normal state 31N, the metastable state 31H and the enable state 31D.

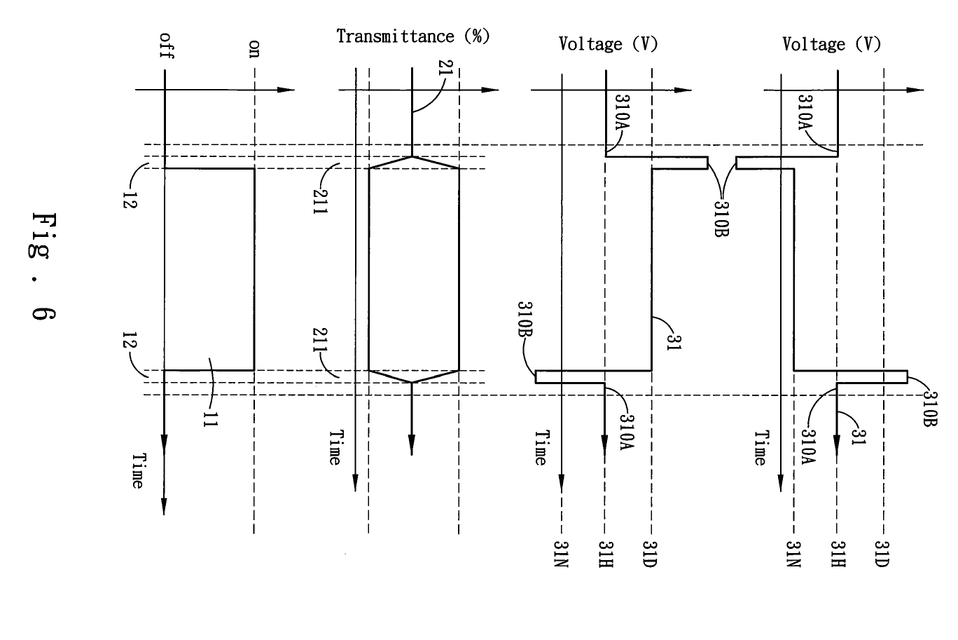

Refer to FIG. 6. In the present invention, the timing signal 31 has a short over-level signal 310B in the transition between each two of the normal state 31N, the metastable state 31H and the enable state 31D. The over-level signal 310B is a material parameter and depends on the optical response time of the LCD panel. The timing signal 31 also has a metastable signal 310A connecting to the over-level signal 310B. The short over-level signal 310B and the metastable signal 310A can further shorten the transit delay 211. As shown in FIG. 6, the timing signal 31 is switched from the metastable state 31H to the normal state 31N and then from the normal state 31N to the metastable state 31H; the timing signal 31 is switched from the metastable state 31H to the enable state 31D and then from the enable state 31D to the metastable state 31H. The transit delay 211 of the light transmission curve 21 can be effectively shortened during the transition of the normal state 31N, metastable state 31H, and enable state 31D. In the present invention, the controller 30 controls the timing signals 31 to make the transit delay 211 coincide with the dark interval 12 of the colored backlight 11. When the present invention is used to generate pure-color lights with the light transmission curve 21 designated by r, g and b in FIG. 5, or when the present invention is used to generate mixed-color lights with the light transmission curve 21 designated by c, m and y in FIG. 5, there is none colored backlight emitted during the transit delay 211 because the transit delay 211 coincides with the dark interval 12 of the colored backlight 11. Therefore, the latter colored backlight does not mix with the former colored backlight.

In conclusion, the present invention controls the timing signal 31 to have the metastable state 31H normally and uses a short over-level signal 310B and the metastable signal 310A to effectively shorten the transit delay 211, whereby the luminous flux is increased. The present invention also modulates the colored backlights 11 to have the dark intervals 12. Thereby, when generating pure-color lights, the present invention can prevent the active colored backlight 11 from mixing with another colored backlight 11 and thus can avoid color deviation; when generating mixed-color lights, the present invention can present the designed colors correctly.

What is claimed is:

1. A enhance driving modulation method and the device for a field sequential color liquid crystal display, comprising steps:
providing a multi-color backlight source sequentially emitting at least two colored backlights;
providing a liquid crystal optical gate illuminated by said colored backlights and having a light blocking state and a light permeable state; and
providing a timing signal having a normal state, a metastable state, and an enable state, wherein said timing signal is normally at said metastable state and switched to said normal state and said enable state to drive said liquid crystal optical gate to said light blocking state or said light permeable state, whereby said liquid crystal optical gate creates a light transmission curve having a transit delay in a transition between each two of said normal state, said metastable state and said enable state.

2. The enhance driving modulation method and the device for a field sequential color liquid crystal display according to claim 1, wherein said timing signal has a short over-level signal in a transition between each two of said normal state, said metastable state and said enable state to accelerate switching said liquid crystal optical gate.

3. The enhance driving modulation method and the device for a field sequential color liquid crystal display according to claim 2, wherein said timing signal further has a short metastable signal connecting to said over-level signal in a transition between each two of said normal state, said metastable state and said enable state to accelerate switching said liquid crystal optical gate.

4. The enhance driving modulation method and the device for a field sequential color liquid crystal display according to claim 1, wherein a dark interval is arranged in a transition of said colored backlights, and said timing signal controls said transit delay to coincide with said dark interval.

5. The enhance driving modulation method and the device for a field sequential color liquid crystal display according to claim 1, wherein said colored backlights include a red backlight, a green backlight and a blue backlight, which are sequentially emitted; said timing signal is an alternating signal; the time interval of two opposite phases of said timing signal is equal to the time interval to sequentially emit said red backlight, said green backlight and said blue backlight once.

6. The enhance driving modulation method and the device for a field sequential color liquid crystal display according to claim 1, wherein said colored backlights have said dark intervals at the instant that said multi-color backlight source begins to emit said colored backlights.
